(19) United States
(12) Patent Application Publication
(10) Pub. No.: US 2021/0264152 A1
(43) Pub. Date: Aug. 26, 2021

(54) HEARING PROTECTION ATTENUATION AND FIT USING A NEURAL-NETWORK

(71) Applicants: Massachusetts Institute of Technology, Cambridge, MA (US); The United States of America, as represented by the Secretary, Dept. of Health and Human Services, Bethesda, MD (US)

(72) Inventors: Christopher Smalt, Arlington, MA (US); Gregory Ciccarelli, Cambridge, MA (US); William Murphy, Cincinnati, OH (US)

(21) Appl. No.: 16/797,554

(22) Filed: Feb. 21, 2020

(51) Int. Cl. G06K 9/00; G08B 21/02; G06T 3/00; G06T 7/11; G06T 3/60; G10L 25/51; G06K 9/62; G06T 7/70; G06Q 50/26

(52) U.S. Cl. CPC G06K 9/00671; G08B 21/02; G06T 3/0006; G06T 7/11; G06T 3/60; G06T 2207/20132; G06K 9/6267; G06T 7/70; G06K 9/00281; G06Q 50/265; G10L 25/51

(57) ABSTRACT

In some embodiments, a method for enforcing hearing protection safety compliance can include: obtaining one or more images of an ear of a user; preprocessing the one or more images to localize the user's ear and/or a hearing protection device (HPD) worn thereabout; providing the one or more preprocessed images to a classification network; receiving an estimated attenuation value as output of the classification network, the estimated attenuation value corresponding to an estimate of the noise attenuation provided by the HPD work about the user's ear; and automatically enforcing compliance with a safety standard using the estimated noise attenuation value.

### STATEMENT REGARDING FEDERALLY SPONSORED RESEARCH

This invention was made with Government support under Grant No. FA8702-15-D-0001 awarded by the U.S. Air Force. The Government has certain rights in the invention.

### BACKGROUND

As is known in the art, the Occupational Safety and Health Administration (OSHA) Guidelines for noise exposure require the use of hearing protection for noise levels over 85 decibels or dB (OSHA Standard 1910.95). Industrial and military noise environments are frequently above this sound level, so hearing protection devices (HPDs) should be used in these situations to prevent permanent, non-reversible hearing damage. One challenge with the use of hearing protection is training and maintaining compliance, particularly in industrial settings.

Conventionally, the amount of noise attenuation provided by an HPD is measured in a specialized acoustic facility using a manual procedure (e.g., ANSI/ASA S12.6-2016). Existing techniques for measuring attenuation require a specialized hearing protector with a microphone embedded and/or that the person see an audiologist and be tested in a special room with certain characteristics.

Recently, more mobile fit-check systems have become commercially available, such as the NIOSH HPD Well-Fit™ system and the 3M™ E-A-Rfit™ Dual-Ear Validation System. Such systems rely on acoustic measurements in a quiet room and are generally limited to one person at a time.

### SUMMARY

Disclosed herein are systems and methods for determining attenuation and fit of a hearing protection device (HPD) based on images of a user's ear. The subject matter disclosed herein can be used in wide range of industrial and military settings including but not limited factories, construction sites, mines, mills, airports, railroads, and military combat and training environments.

According to one aspect of the present disclosure, a method for enforcing hearing protection safety compliance may include: obtaining one or more images of an ear of a user; preprocessing the one or more images to localize the user's ear and/or a hearing protection device (HPD) worn thereabout; providing the one or more preprocessed images to a classification network; receiving an estimated attenuation value as output of the classification network, the estimated attenuation value corresponding to an estimate of the noise attenuation provided by the HPD work about the user's ear; and automatically enforcing compliance with a safety standard using the estimated noise attenuation value.

In some embodiments, preprocessing the one or more images can include at least one of: cropping the one or more images; applying one or more affine transformations to the images; or flipping the one or more images. In some embodiments, the method can include determining a fit classification associated with the HPD based on the estimated noise attenuation value and an actual or expected noise level for a target environment. In some embodiments, the method can include measuring the expected noise level for the target environment using a microphone. In some embodiments, automatically enforcing compliance can include at least one: displaying a visual notification indicating whether the user has adequate hearing protection for the target environment; or generating an audio alert if the user does not have adequate hearing protection. In some embodiments, the method can further include transmitting the estimated noise attenuation value or the fit classification to a reporting system. In some embodiments, the one or more images can include a plurality of images and the method can include: receiving an estimated attenuation value for each of the plurality of images; and determining the fit classification based on the plurality estimated attenuation values.

According to another aspect of the present disclosure, a system can include a processor and a non-volatile memory. The memory can store computer program code that when executed on the processor causes the processor to execute embodiments of the method described above.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a diagram of an illustrative safety compliance system, according to some embodiments of the present disclosure.

FIGS. 2A and 2B are photographs showing hearing protection devices (HPDs) inserted into a user's ears.

FIG. 3 is a block diagram of a compliance determination subsystem that can be used within the system of FIG. 1, according to some embodiments of the present disclosure.

FIG. 4A is an original photograph of a user wearing an HPD.

FIG. 4B is an image illustrating the location of the HPD in FIG. 4A.

FIG. 4C is a localized version of the photograph shown in FIG. 4A.

FIG. 5 is diagram of a convolutional network architecture that can be used for HPD attenuation and fit, according to some embodiments of the present disclosure.

FIG. 6 is diagram of another convolutional network architecture that can be used for HPD attenuation and fit, according to some embodiments of the present disclosure.

FIG. 7 is a flow diagram of a method for automatic monitoring of, and enforcing compliance with, hearing protection safety standards, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

As used herein, the terms “subsystem” and “module” generally refer to a collection of hardware and/or software configured to perform and execute the processes, steps, or other functionality described in conjunction therewith.

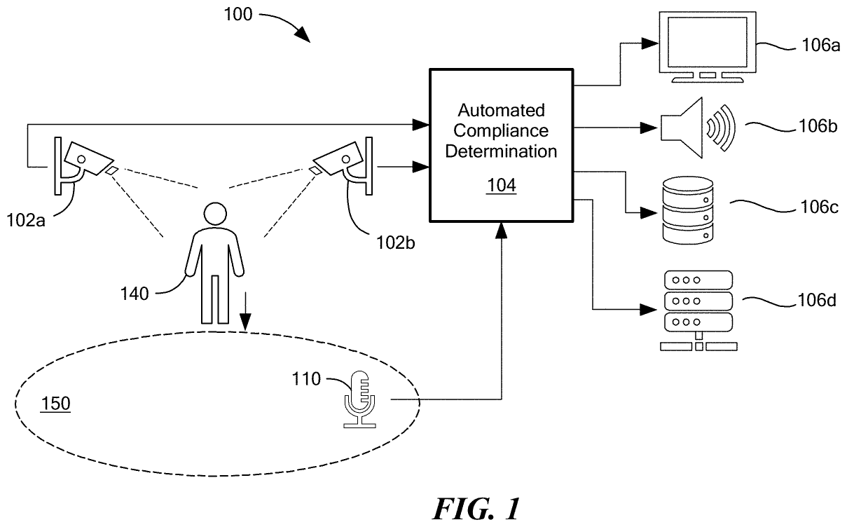

FIG. 1 shows a system 100 that can be used for monitoring and enforcing compliance with safety standards, according to some embodiments of the present disclosure. In particular, system 100 can be used to automatically determine if a user 140 has an adequate hearing protection for a particular environment 150 (“target environment”), and to monitor and enforce usage of HPDs within the target environment 150. Target environment 150 can include, for example, a factory, construction site, mining operations, airport, or military combat or training environment. Examples of HPDs include in-ear devices (e.g., foam or plastic earplugs) and over-ear devices (e.g., earmuffs).

The illustrative system 100 can include one or more cameras 102a, 102b (102 generally) coupled as inputs to a compliance determination subsystem 104, and one or more output devices 106a, 106b, 106c, 106d, etc. (106 generally) coupled as outputs of the subsystem 104.

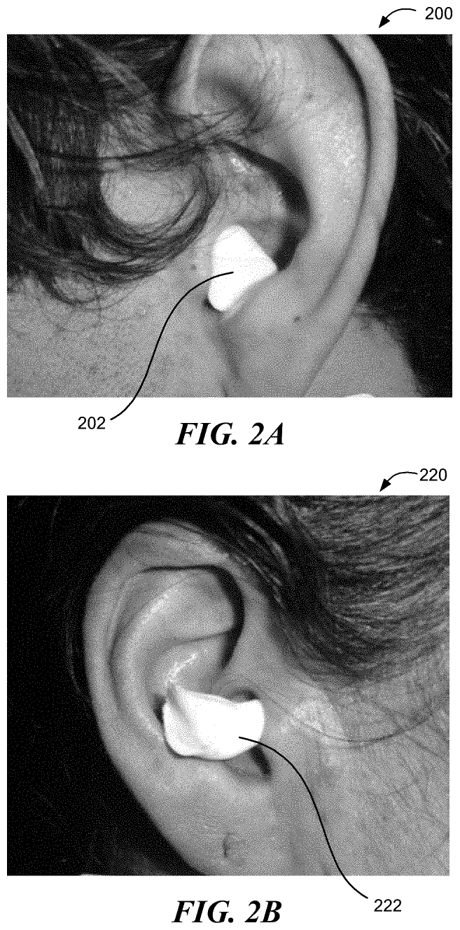

Cameras 102 may be configured to capture images of a user 140 and, more particularly, of the user's ears. Turning briefly to FIG. 2A, a first photograph 200 is an example of a “good” fit for an HPD 202 inserted into a user's left ear. That is, HPD 202 is oriented within the user's left ear such that there are relatively few (and ideally no) gaps between the edges of the HPD 202 and the ear. In FIG. 2B, a second photograph 220 is an example of a “poor” fit an HPD 222 inserted into a user's right ear. It can be seen that HPD 222 is not properly oriented within the user's right ear, resulting in significant gaps around the edges of the HPD where noise can reach the user's right ear canal. HPD 202 of FIG. 2A may provide about 20 dB of noise attenuation whereas HPD 222 of FIG. 2B may provide about 5 dB of noise attenuation.

Returning to FIG. 1, cameras 102 can include video cameras and/or still cameras. In some embodiments, cameras 102 can include surveillance-style cameras installed near the perimeter of target environment 150 (e.g., at an entrance of a factory building). As shown in FIG. 1, the system 100 can include multiple cameras 102a, 102b positioned to capture different angles of the user 140. For example, a first camera 102a can be positioned to capture an image of the user's right ear and a second camera 102b can be positioned to capture an image of the user's left ear. In other embodiments, cameras 102 may correspond to one or more cameras within a smartphone or other mobile device. In this case, the user 140 may hold the mobile device's camera to capture images of both ears. The subject matter disclosed herein can be used with many different types and configurations of cameras.

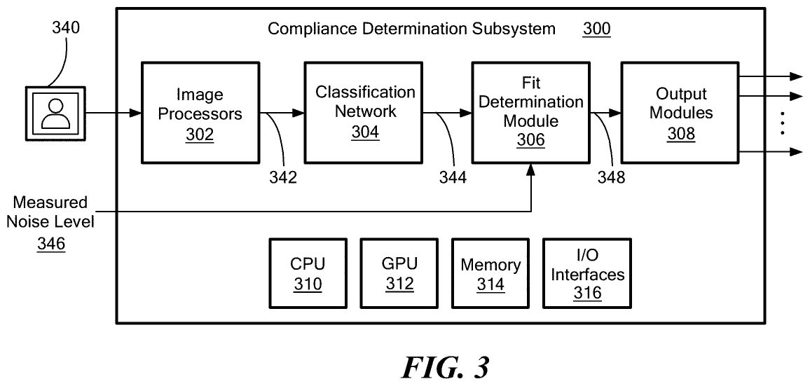

Compliance determination subsystem 104 is configured to estimate/predict the attenuation of the user's hearing protection from images captured by the one or more cameras 102. As described in detail below in the context of FIG. 3, safety compliance subsystem 104 can use an end-to-end classification network trained to estimate HPD attenuation from an input image. Subsystem 104 can compare the estimated attenuation value to a minimum attenuation threshold value to determine if the user is wearing adequate hearing protection. The minimum attenuation threshold may be selected based on an average or maximum expected noise level found in the target environment 150 and maximum permissible noise level. For example, in a factory setting, the average expected noise level may be 100 dB, the maximum permissible noise level may be 85 dB per OSHA Standard 1910.95, and thus the minimum attenuation threshold may be selected as 15 dB. In this example, subsystem 104 may classify the user's HPD fit as “poor” if it estimates less than 15 dB of attenuation and “good” otherwise.

In some embodiments, system 100 can include a microphone 110 to measure noise levels within the target environment 150 and use the measured noise levels to classify the user's HPD fit. That is, system 100 can use actual noise level instead of expected noise level. In some embodiments, system 100 can include an array of microphones installed at different locations within the target environment 150. In this case, the environment noise level may be calculated as an average of measurements taken across the microphone array.

In general, compliance determination subsystem 104 can output one or more of: (a) a numerical value corresponding to the estimated attenuation provided by the HPD, or (b) a classification such as “good” or “poor” indicating how well the HPD “fits” in or about the user's ear. For brevity, these outputs are referred to herein as “attenuation” and “fit,” respectively,

In some embodiments, subsystem 104 can receive separate images of the user's left and right ear. Using the separate images, subsystem 104 can estimate attenuation separately for each ear and then calculate a total or average attenuation estimate (e.g., as a mathematical sum or average of the individual-ear estimates). The total/average attenuation estimate can then be compared to a predetermined threshold value to determine fit. A more detailed discussion of using multiple images to determine attenuation/fit is discussed below in the context of FIG. 3.

Having determined HPD attenuation and/or fit, compliance determination subsystem 104 can generate one or more outputs provided to output devices 106. Subsystem 104 can generate one or more output related to monitoring and enforcing compliance with safety standards. For example, subsystem 104 may generate a visual notification to be displayed on a screen 106a indicating that user 140 does or does not have adequate hearing protection for target environment 150. As another example, subsystem 104 may generate an audio alert to be output by a speaker 106b if user 140 does not have adequate hearing protection. In some embodiments, screen 106a and/or speaker 106b may be positioned near an entrance to the target environment 150 such that user 140 is provided safety compliance notification in real time as they enter the environment 150. In some embodiments, subsystem 104 can send HPD attenuation and/or fit information to storage device 106c or a remote computer system 106d where it can be stored and letter used for compliance monitoring and reporting. The output devices 106a-106d are merely illustrative and other types and combinations of output devices can be used.

In some embodiments, system 100 can be implemented in whole or in part on a smartphone, tablet, laptop or other computing device. For example, cameras 102, microphone 110, screen 106a, speaker 106b, and storage device 106c may correspond to hardware components of a smartphone, and compliance determination subsystem 104 may correspond to an app configured to execute on the smartphone and access those hardware components.

FIG. 3 shows an embodiment of a compliance determination subsystem 300 that can be provided within a safety compliance system, such as system 100 of FIG. 1. The illustrative subsystem 300 can include one or more image processors 302, a classification network 304, a fit determination module 306, and one or more output modules 308. In some embodiments, components 302-308 may be provided as computer software configured to perform and execute the processes, steps, or other functionality described in conjunction therewith.

Subsystem 300 can also include a central processing unit (CPU) 310, a graphics processing unit (GPU) 312, memory 314, and one or more input/output (I/O) interfaces 316. Memory 314 can include one or more memory devices for storing computer instructions and data. The computer instructions may be executable by CPU 310 and/or GPU 312. I/O interfaces can include, for example, a wired or wireless network interface, a microphone input, a speaker output, and a video output.

In some embodiments, components 310-316 may correspond to components of a smartphone or tablet, and components 302-308 may be implemented within an app configured to execute on the smartphone/tablet. In some embodiments, some of the processing described herein in the context of subsystem 300 may be performed on client device (e.g., a smartphone, tablet, or laptop) and some of the processing may be performed on a server device. For example, classification network 304 can be implemented an executed on a remote server to conserve computing resources on the client.

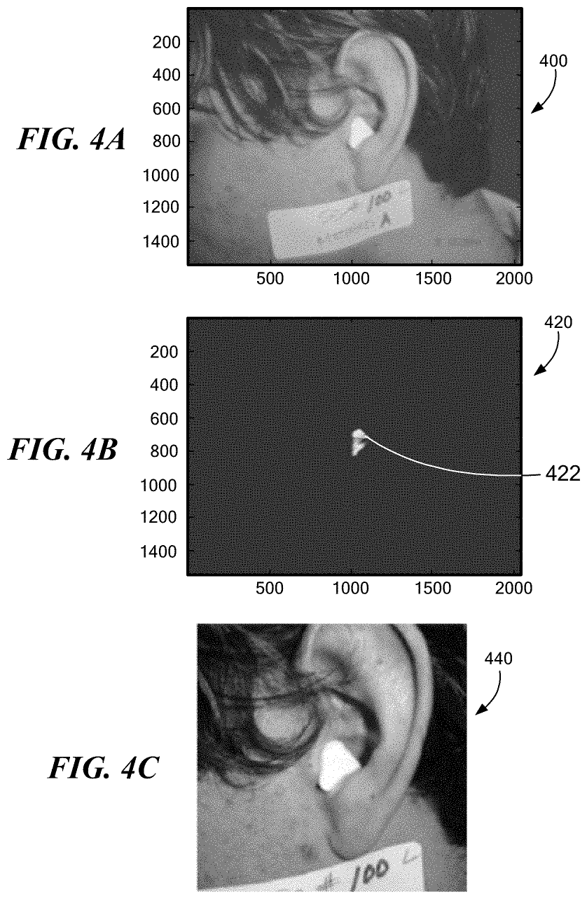

Subsystem 300 can receive as input, an image 340 of a user in which at least one of the user's ears is visible. Image processors 302 can include hardware and/or software to preprocess the image 340 to approximately localize the ear and an HPD inserted therein. An example of this is shown in FIGS. 4A, 4B, and 4C. FIG. 4A shows an original input image 400, such as an image obtained from a video or still camera. That is, image 400 in FIG. 4A (and FIG. 4B) can correspond to image 340 in FIG. 3. As shown in FIG. 4B, an HPD 422 can be located within the image 400. In some embodiments, the HPD 422 can be located based on color intensity (e.g., by finding green pixels in the image). In some embodiments, the ear and/or HPD can be located using a subtraction technique on images of the user's left and right ears. In some embodiments, the HPD may have a known structural form and computer vision techniques for identifying a particular structural form can be used to locate the HPD. In some embodiments, the known structure of the pinnae can be used to locate the HPD based on the reasonable assumption that the HPD would be near the centroid of the pinnae.

Once the location of the HPD 422 is determined, image processors 302 can generate a cropped image 440 having dimensions suitable for input to classification network 304 (e.g., 128×128 or 240×240 pixels). In addition to cropping, image processors 302 may perform one or more affine transformations (e.g., translation, scaling, reflection, etc.) on the original image 400 to localize (or “identify”) the user's ear and/or the HPD within image 440 that is provided as input to the classification network. In some embodiments, image processors 302 may adjust image brightness, contrast, and/or saturation to compensate for different camera angles, lighting conditions, etc. Techniques for localizing/identify an object within an image are sometimes referred to as automatic object segmentation and labeling.

In some embodiments, classification network 304 may be trained using only images of left ears or only images of right ears. In this case, image processors 302 may flip the image 440 horizontally to match the training set as needed (e.g., flip a right-ear image to appear as a left-ear image). In some embodiments, subsystem 300 can receive as input an image 304 a user's whole body, upper body, or head. In this case, image processors 302 can use computer vision techniques to locate the user's ear or ears within the original image, and then use the aforementioned techniques to locate the HPD within an ear. In some embodiments, subsystem 300 can receive a video feed as input, extract still images of a user from the video feed, and the perform one or more of the aforementioned techniques to locate the user's ear and/or the HPD.

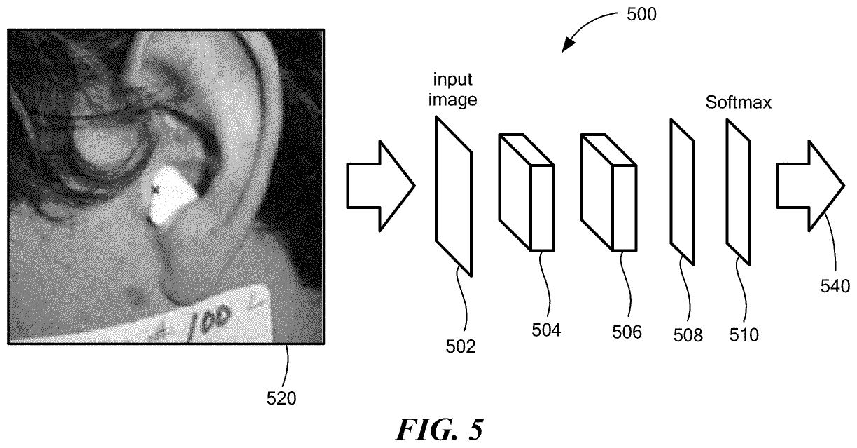

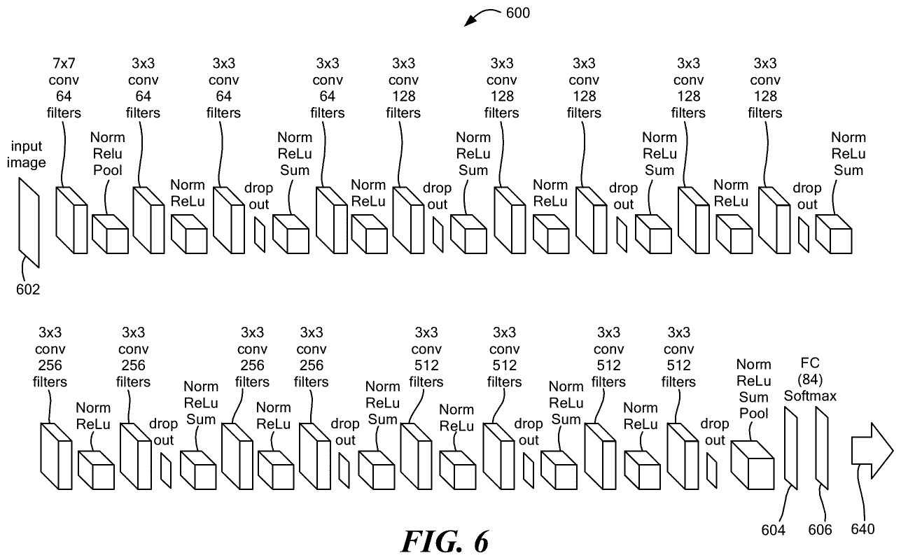

Returning to FIG. 3, image processors 302 can provide the preprocessed image data 342 as input to classification network 304. Classification network 304 can include a deep neural network (DNN) trained using a set of images of HPDs inserted into individual's ears. The classification network 304 can predict the attenuation of the hearing protection from an image 342 of a user's ear. The output 344 of network 344 can be a numeric value corresponding to the estimated noise attenuation provided by the HPD in the user's ear. While many different DNN architectures can be used within classification network 304, two example architectures are shown and described below in the contexts of FIGS. 5 and 6.

Fit determination module 306 can receive the attenuation estimate 344 as input and provide a fit classification 348 as output (e.g., “good” fit or “poor” fit). For example, fit determination module 306 can compare the estimated attenuation value 344 to a minimum attenuation threshold value to determine if the user is wearing adequate hearing protection. The minimum attenuation threshold may be preselected based on an expected or actual noise level for a given environment and a maximum permissible noise level. Actual noise level 346 can be measured using a microphone (e.g., microphone 110 in FIG. 1). Expected noise levels for one or more target environments can be preconfigured and stored in memory 314. Likewise, the maximum permissible noise level can be stored in memory 314.

In some embodiments, fit determination module 306 may utilize multiple attenuation estimate values 344 to determine HPD fit 348. For example, multiple images of the user's ear may be captured (e.g., as a video stream or as multiple still images), preprocessed, and provided as input to classification network 304. The multiple corresponding classification outputs 344 may be averaged or otherwise combined to determine fit 348. In some embodiments, fit determination module 306 may use attenuation estimates of both the left and right ear to determine overall fit.

FIG. 5 shows an example of a convolutional neural network architecture 500 that can be used, for example, within classification network 304 of FIG. 3. The illustrative architecture 500 includes an input layer 402 to receive input image data 520, a first convolutional layer 504, a second convolutional layer 506, a fully connected (FC) layer 508, and an output layer 510. In some embodiments, output layer 410 may implement a softmax function that outputs a fit classification 540 (e.g., “good” or “bad” fit). In other embodiments, FC layer 508 may correspond to the output layer and network 500 may output 540 an estimated attenuation value instead of a fit classification. Thus, softmax layer 510 can be omitted in some embodiments.

FIG. 6 shows another example of a convolutional neural network architecture 600 that can be used, for example, within classification network 304 of FIG. 3. The illustrative architecture 600 can include an input layer 602 and a fully connected (FC) layer 604 connected by a plurality of intermediate layers, such as convolutional layers (cony), rectified linear unit (ReLu) layers, and drop outs. In some embodiments, a softmax layer 606 may be included to generate a fit classification output 640 (e.g., “good” or “bad” fit). The selection and arrangement of intermediate layers may be based, for example, on the ResNet18 network architecture.

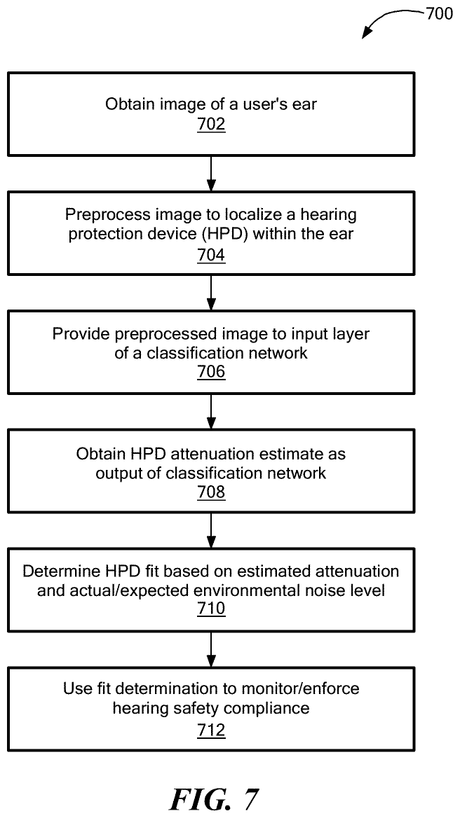

Referring to FIG. 7, a method 700 can be used for automated monitoring of, and enforcing compliance with, hearing protection safety standards, according to some embodiments of the present disclosure. The illustrative method 700 can be implemented within system 100 of FIG. 1 and, more particularly, within subsystem 104.

At block 702, an image can be obtained of a user's ear using, for example, a video camera or still camera. At block 704, the image can be preprocessed to locate/identify the user's ear and/or the HPD worn about the user's ear (e.g., worn within or over the ear). Examples of image preprocessing techniques that can be used are described above in the context of FIG. 3.

At block 706, the preprocessed image can be provided to an input layer of a classification network, such as network 500 of FIG. 5 or network 600 of FIG. 6. The classification network can be trained to estimate an amount of noise attenuation provided by an HPD from images of the HPD inserted into an individual's ear. In some embodiments, the classification network can output the estimated attenuation as a numeric value (block 708).

At block 710, HPD fit (e.g., “good” or “poor” fit) can be determined based on the estimated attenuation and an actual or expected environmental noise level. As previously discussed, actual noise level can be determined using a microphone located within the target environment, whereas expected noise for one or more target environments can be preconfigured in memory. In some embodiments, fit can be determined based on a maximum permissible noise level such as defined by OSHA Standard 1910.95.

At block 712, the determined HPD fit can be used to monitor and/or enforce hearing safety compliance. For example, as previously discussed, a visual notification can be displayed to the user or others indicating whether the user does or does not have adequate hearing protection for the target environment. As another example, an audio alert can be generated if the user does not have adequate hearing protection. As another example, information related to HPD attenuation and/or fit can be stored or transmitted for subsequent monitoring and reporting purposes.

The subject matter disclosed herein provides several technical advantages such as the ability to instantaneous/real-time feedback to individuals on HPD fit status without the need for specialized equipment (e.g., using only a smartphone). In contrast to existing systems, the subject matter disclosed herein can be used in the noisy environment and are not limited to one person at a time, providing continuous safety monitoring. This systems and methods disclosed herein can be used in a variety of industrial and military settings where hearing protection is needed.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for enforcing hearing protection safety compliance, the method comprising:
obtaining one or more images of an ear of a user;
preprocessing the one or more images to localize the user's ear and/or a hearing protection device (HPD) worn thereabout;
providing the one or more preprocessed images to a classification network;
receiving an estimated attenuation value as output of the classification network, the estimated attenuation value corresponding to an estimate of the noise attenuation provided by the HPD work about the user's ear; and
automatically enforcing compliance with a safety standard using the estimated noise attenuation value.

2. The method of claim 1, wherein preprocessing the one or more images comprises at least one of:
cropping the one or more images;
applying one or more affine transformations to the images; or
flipping the one or more images.

3. The method of claim 1, comprising:
determining a fit classification associated with the HPD based on the estimated noise attenuation value and an actual or expected noise level for a target environment.

4. The method of claim 3, comprising:
measuring the expected noise level for the target environment using a microphone.

5. The method of claim 3, wherein automatically enforcing compliance comprises at least one:
displaying a visual notification indicating whether the user has adequate hearing protection for the target environment; or
generating an audio alert if the user does not have adequate hearing protection.

6. The method of claim 3, comprising:
transmitting the estimated noise attenuation value or the fit classification to a reporting system.

7. The method of claim 3, wherein the one or more images include a plurality of images, the method comprising:
receiving an estimated attenuation value for each of the plurality of images; and
determining the fit classification based on the plurality estimated attenuation values.

8. A system comprising:
a processor; and
a non-volatile memory storing computer program code that when executed on the processor causes the processor to execute a process operable for:
obtaining one or more images of an ear of a user;
preprocessing the one or more images to localize the user's ear and/or a hearing protection device (HPD) worn thereabout;
providing the one or more preprocessed images to a classification network;
receiving an estimated attenuation value as output of the classification network, the estimated attenuation value corresponding to an estimate of the noise attenuation provided by the HPD work about the user's ear; and
automatically enforcing compliance with a safety standard using the estimated noise attenuation value.

9. The system of claim 8, wherein preprocessing the one or more images comprises at least one of:
cropping the one or more images;
applying one or more affine transformations to the images; or
flipping the one or more images.

10. The system of claim 8, comprising:
determining a fit classification associated with the HPD based on the estimated noise attenuation value and an actual or expected noise level for a target environment.

11. The method of claim 10, comprising:
measuring the expected noise level for the target environment using a microphone.

12. The method of claim 10, wherein automatically enforcing compliance comprises at least one:
displaying a visual notification indicating whether the user has adequate hearing protection for the target environment; or
generating an audio alert if the user does not have adequate hearing protection.

13. The method of claim 10, comprising:
transmitting the estimated noise attenuation value or the fit classification to a reporting system.

14. The method of claim 10, wherein the one or more images include a plurality of images, the method comprising:
receiving an estimated attenuation value for each of the plurality of images; and
determining the fit classification based on the plurality estimated attenuation values.
